(19) United States
(12) Patent Application Publication
(10) Pub. No.: US 2007/0002034 A1
(43) Pub. Date: Jan. 4, 2007

(54) Image readout apparatus

(75) Inventor: Kazuo Hakamata, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/477,588

(22) Filed: Jun. 30, 2006

(30) Foreign Application Priority Data
Jun. 30, 2005 (JP) 191395/2005

(51) Int. Cl. G09G 5/00

(52) U.S. Cl. 345/204

(57) ABSTRACT

An image readout apparatus with a panel light source that allows a high yield rate for mounting the panel driver ICs, and enhanced connection reliability for the driver ICs with reduced cost. The panel light source is constituted by a plurality of El blocks arranged side by side, each including a plurality of line electrodes disposed in stripes, and a flat plate electrode disposed opposite to the plurality of line electrodes with an electroluminescence layer interposed between them. Each of the corresponding line electrodes in different EL blocks is electrically connected with each other through a wire. A drive current is applied to the line electrodes of a plurality of EL blocks connected through the wire, and to the flat plate electrode of the EL block to be caused to emit luminescence respectively by two panel driver ICs when causing the panel light source to emit the readout light beam.

### BACKGROUND OF THE INVENTION

1. Field of the Invention

The present invention relates to an image readout apparatus for reading out image information recorded on an image recording medium by irradiating linear light beams thereon using electroluminescence elements.

2. Description of the Related Art

In the field of medical X-ray imaging, solid-state detectors are proposed in order to reduce an amount of dosage exposed to a subject, and to improve diagnostic capabilities. Such detectors use a photoconductor, such as an X-ray-sensitive selenium plate made of, for example, a-Se as an electrostatic recording medium, and radiation, such as X-ray, that represents radiation image information is irradiated on the electrostatic recording medium to record the image information thereon. One of the methods for obtaining image information recoded on the solid-state detector is known as described, for example, in U.S. Pat. No. 6,930,303. In the method, the image information recorded on the solid-state detector is obtained by scan exposing the solid-state detector with a linear readout light beam.

In the patent publication described above, a panel light source constituted, for example, by electroluminescence elements is used as the readout light source for emitting the readout light beams. The panel light source includes a plurality of line electrodes and a flat plate electrode disposed opposite to the line electrodes with an EL layer interposed therebetween, and luminescence is emitted from the EL layer sandwiched by the line electrodes and flat plate electrode by applying a drive current to the line and flat plate electrodes.

As one of the panel light sources using electroluminescence elements, a panel light source which is divided into a plurality of blocks, and each of the blocks is controlled individually is known as described, for example, in Japanese Unexamined Patent Publication No. 7(1995)-114986. The EL unit described in the patent publication described above includes: a block electrode (flat plate electrode); a plurality of common line electrodes (line electrodes), and an EL layer sandwiched between the block electrode and the plurality of common line electrodes. The block electrode and common line electrodes of each block are electrically connected to a driver IC, and the application of the drive current to each block is controlled by the driver IC.

The use of the EL unit described in Japanese Unexamined Patent Publication No. 7(1995)-114986 as the readout light source of the image recording medium, however, requires control driver ICs amounting to as many as the number of blocks to be mounted at a narrow pitch. This causes a problem of decreased yield rate for mounting the IC chips. More specifically, when the EL unit is used as the panel light source of a solid-state detector used for mammography, the distance between the line electrodes needs to be less than 50 μm. Consequently, each of the driver ICs needs to be mounted with spacing narrower than 50 μm. For example, the driver ICs need to be thermocompression bonded using an anisotropically conductive adhesive (ACF) with spacing of 40 μm. When performing thermocompression bonding with such a narrow spacing, the yield rate may be decreased without precise control of shrinkage rate, thermocompression temperature, and ambient temperature/humidity. Further, it requires the control driver IC for each of the EL blocks, resulting in a high manufacturing cost.

In view of the circumstances described above, it is an object of the present invention to provide an image readout apparatus with a panel light source that allows a high yield rate for mounting the panel driver ICs, and enhanced connection reliability thereof with reduced cost.

### SUMMARY OF THE INVENTION

The image readout apparatus of the present invention is an apparatus, comprising:

an image recording medium with image information recorded thereon;

a panel light source constituted by electroluminescence elements for emitting linear readout light beams onto the image recording medium; and

a panel driver IC for controlling the application of a drive current to the panel light source such that the readout light beam is scan irradiated on the image recording medium from the panel light source, wherein:

the panel light source is constituted by a plurality of EL blocks arranged side by side, each including a plurality of line electrodes disposed in stripes, and a flat plate electrode disposed opposite to the plurality of line electrodes with an electroluminescence layer interposed therebetween;

each of the corresponding line electrodes in different EL bocks is electrically connected with each other through a wire; and

the panel driver IC applies the drive current to the line electrodes of a plurality of EL blocks connected through the wire, and to the flat plate electrode of the EL block to be caused to emit luminescence when causing the panel light source to emit the readout light beam.

The panel light source may be an inorganic EL panel using an inorganic EL material, or an organic EL panel using an organic EL material.

Further, any number of panel driver ICs may be used as long as each panel driver IC is capable of controlling the application of the drive current to a plurality of EL blocks. For example, a single panel driver IC may be used for controlling the application of the drive current to all of the EL blocks, or a plurality of panel driver ICs may be used for controlling the application of the drive current to two or more EL blocks. Alternatively, two panel driver ICs may be used, one of which is electrically connected to each of the line electrodes of all the EL blocks, and the other of which is electrically connected to each of the flat plate electrodes of all the EL blocks.

Still further, the wiring may have any pattern as long as it is capable of electrically connecting each of the corresponding line electrodes with each other in different EL blocks, and electrically connecting each of the line electrodes of a plurality of EL blocks to the panel driver IC. For example, it may have a pattern for connecting each of the corresponding line electrodes of all the EL blocks in parallel, and the wiring is electrically connected to the panel driver IC.

Further, each of the line electrodes may be connected to the panel driver IC by any means as long as they are electrically connected to the panel driver IC. For example, they may be electrically connected to the panel driver IC using a flexible printed circuit board, or an anisotropically conductive rubber sheet.

Still further, any mounting method may be used for mounting the panel driver IC as long as the IC is electrically connected to each of the line electrodes. Preferably, however, it is mounted on the surface of the panel light source opposite to the readout light beam emitting surface.

Further, a configuration may be adopted in which the panel driver IC controls to cause the panel light source to further emit the readout light beams for erasing residual image information remaining in the image recording medium after emitting the readout light beams for reading out the image information from the image recording medium. Here, a configuration may be adopted in which the panel driver IC applies a reversely biased voltage with respect to the drive current to each of the line electrodes and each of the flat plate electrodes of a plurality of EL blocks.

According to the image readout apparatus of the present invention, the drive current is applied to the line electrodes of a plurality of EL blocks connected through a wire, and to the flat plate electrode of the EL block to be caused to emit luminescence by the panel driver IC when causing the panel light source to emit the readout light beam. Thus, a plurality of EL blocks may be controlled by a single panel driver IC, which reduces the number of panel driver ICs to be mounted. This allows a high yield rate for mounting the panel driver ICs, and enhanced connection reliability thereof with reduced cost by avoiding a narrow-pitch mounting for a plurality of panel driver ICs.

When each of the corresponding line electrodes in different EL blocks is connected in parallel, the application of the drive current to all the line electrodes may be controlled by a single panel driver IC, so that further enhancement in the connection reliability may be achieved with further reduced cost.

If each of the line electrodes is electrically connected to the panel driver IC using a flexible printed circuit board, or an anisotropically conductive rubber sheet, the connection resistance between the panel driver IC and panel light source may be reduced, thereby minimizing the luminance variation arising from the connection resistance in the panel light source.

Further, if the panel driver IC is mounted on the surface of the panel light source opposite to the readout light beam emitting surface, no space is required on the light emitting surface for mounting the panel driver ICs. This may reduce a gap between a human breast wall and the image recording area of a solid-state detector when taking a mammogram.

Still further, if the configuration is adopted in which the panel driver IC controls to cause the panel light source to further emit the readout light beams for erasing residual image information remaining in the image recording medium after emitting the readout light beams for reading out the image information from the image recording medium, residual image information remaining in the image recording medium after the image is read out therefrom may be erased. This may prevent image quality degradation due to the residual image information when the image recording medium is repeatedly used for recording image information.

Further, if the panel driver IC further includes a function to apply a reversely biased voltage with respect to the drive current to each of the line electrodes and each of the flat plate electrodes of a plurality of EL blocks, the migration in each of the EL blocks may be prevented.

### BRIEF DESCRIPTION OF THE DRAWINGS

FIG. 1 is a structural diagram illustrating a preferred embodiment of the image readout apparatus of the present invention.

FIG. 2 is a schematic diagram of an example panel light source used for the image readout apparatus shown in FIG. 1.

FIG. 3 is a schematic diagram of an example panel light source in the image readout apparatus of the present invention.

FIG. 4 is a circuit diagram illustrating an example of a driver IC shown in FIG. 3.

FIG. 5 is a schematic diagram illustrating another embodiment of the panel light source in the image readout apparatus of the present invention.

FIG. 6 is a schematic diagram illustrating an example mounted state of the driver IC of the panel light source shown in FIG. 5.

FIG. 7 is a schematic diagram illustrating another embodiment of the panel light source in the image readout system of the present invention.

FIG. 8 is a schematic diagram illustrating still another embodiment of the panel light source in the image readout system of the present invention.

FIG. 9 is a schematic diagram illustrating a further embodiment of the panel light source in the image readout system of the present invention.

FIG. 10 is a schematic diagram illustrating another example mounted state of the driver IC of the panel light source.

FIG. 11 is a schematic diagram illustrating still another example mounted state of the driver IC of the panel light source.

FIG. 12 is a schematic diagram illustrating a further example mounted state of the driver IC of the panel light source.

### DESCRIPTION OF THE PREFERRED EMBODIMENTS

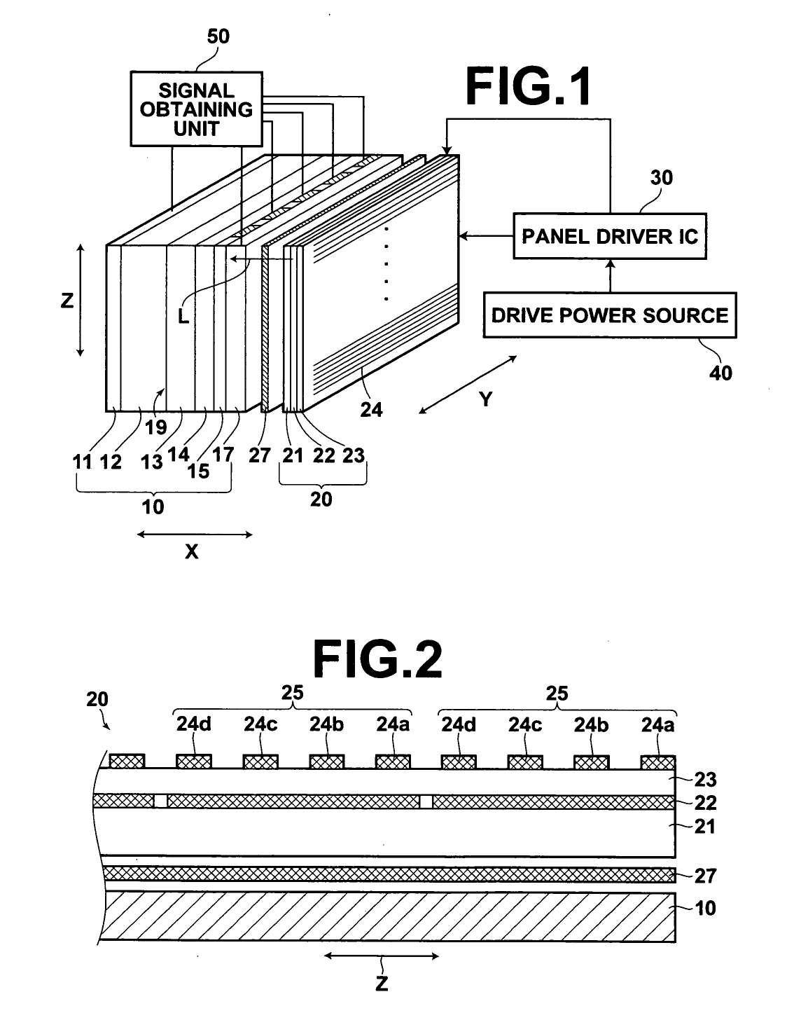

Hereinafter, embodiments of the image readout apparatus of the present invention will be described in detail with reference to accompanying drawings. FIG. 1 is a schematic structural diagram illustrating a preferred embodiment of the image readout apparatus of the present invention. The image readout apparatus 1 includes an image recording medium 10 with image information recorded thereon; and a panel light source 20 for scan exposing the image recording medium 10 with a linear readout light beam L.

First, the image recording medium 10 will be described with reference to FIG. 1. The image recording medium 10 is a so-called optical readout type solid-state detector as described, for example, in Japanese Unexamined Patent Publication No. 2000-284056. It has a layer structure that includes a first electrode 11, a recording photoconductive layer 12, a charge transport layer 13, a readout photoconductive layer 14, and a readout electrode 15 layered on top of another.

The first electrode 11 is made of, for example, NESA film or the like, and includes a plurality of line electrodes extending substantially in parallel with each other in the arrow Y direction. The line electrodes are electrically insulated with each other. The recording photoconductive layer 12 is made of, for example, amorphous selenium, and shows electrical conductivity when exposed to recording electromagnetic waves (light or radiation) and produces charge pairs. The charge transport layer 13 is layered on top of the recording photoconductive layer 12. The charge transport layer 13 acts substantially as an insulator with respect to negative charges, and acts substantially as a conductor with respect to positive charges. The readout photoconductive layer 14 is made of, for example, amorphous selenium, and shows electrical conductivity when exposed to a readout light beam and produces charge pairs. Further, the readout electrode 15, which includes a plurality of line electrodes extending in the arrow Z direction, is layered on top of the readout photoconductive layer 14. The line electrodes of the readout electrode 15 are made of a material that transmits the readout light beam, such as ITO (Indium Tin Oxide) film.

Here, a charge storage section 19 is formed at the interface between the recording photoconductive layer 12 and the charge transport layer 13. That is, when electrons produced in the recording photoconductive layer 12 move toward the readout electrode 15 due to an electric field formed between the first electrode 11 and the readout electrode 15, the movement of the electrons is blocked by the charge transport layer 13. Accordingly, an amount of charges corresponding to the amount of exposed recording electromagnetic waves is stored as an electrostatic latent image in the charge storage section 19. In this way, the image information is recorded on the image recording medium 10.

Here, when image information is recorded on the image recording medium 10, a high voltage is applied between the first electrode 11 and the readout electrode 15 from a signal obtaining unit 50. Thereby, the first electrode 11 is charged with negative charges, and the readout electrode 15 is charged with positive charges. Then, when a recording electromagnetic wave is irradiated from the side of the first electrode 11, positive/negative charge pairs are produced in the recording photoconductive layer 12 according to the exposed amount of the recording electromagnetic wave of the charge pairs, positive holes move toward the first electrode 11, where they combine with the negative charges and disappear. Meanwhile, electrons of the charge pairs move toward the readout electrode 15, but the movement is blocked by the charge transport layer 13. Consequently, image information is recorded in the charge storage section 19 as an electrostatic latent image.

When reading out the image information recorded in the charge storage section 19, a linear readout light beam L extending in the arrow Y direction is emitted from the panel light source 20, and the image recording medium 10 is scan exposed with the readout light beam L in the direction of arrow Z from the side of the readout electrode 15. Then, charge pairs are generated in the readout photoconductive layer 14 according to the amount of readout light beam L irradiated thereon. Positive holes of the charge pairs generated in the readout photoconductive layer 14 transmit through the charge transport layer 13 and reach the charge storage section 19, where they combine with the negative charges stored therein and disappear. Meanwhile, electrons of the charge pairs move to the readout electrode 15, where they combine with the positive charges. Current flows through the readout electrode 15 when the electrons and the positive charges combine at the readout electrode 15. The image information is read out by detecting changes in the current by the signal obtaining unit 50.

FIG. 2 is a cross-sectional view of a preferred embodiment of the panel light source 20 of the image readout apparatus 1 shown in FIG. 1. The panel light source 20 will be described with reference to FIG. 2. The panel light source 20 is constituted by a plurality of EL blocks 25 arranged side by side, each including a plurality of line electrodes 24a to 24d disposed in stripes, and a flat plate electrode 22 disposed opposite to the plurality of line electrodes 24 with an electroluminescence layer 23 interposed therebetween.

More specifically, the panel light source 20 includes an optically transparent substrate 21, such as a glass substrate or the like, on which a plurality of flat plate electrodes 22 are disposed, and an EL layer 23 made of an organic or inorganic EL material is formed on top of the flat plate electrodes 22. Then, a plurality of line electrodes 24a to 24d disposed in stripes is provided on top of the EL layer 23. Here, an EL block 25 is constituted by a flat plate electrode 22, a plurality of line electrodes 24a to 24d, and an EL layer 23 sandwitched therebetween, and the panel light source 20 is constituted by a plurality of EL blocks arranged side by side. The EL block 25 is constructed such that a readout light beam is emitted from the EL layer 23 sandwitched between the flat plate electrode 22 and the line electrodes 24a to 24d when a drive current is applied to the flat plate electrode 22 and the line electrodes 24a to 24d.

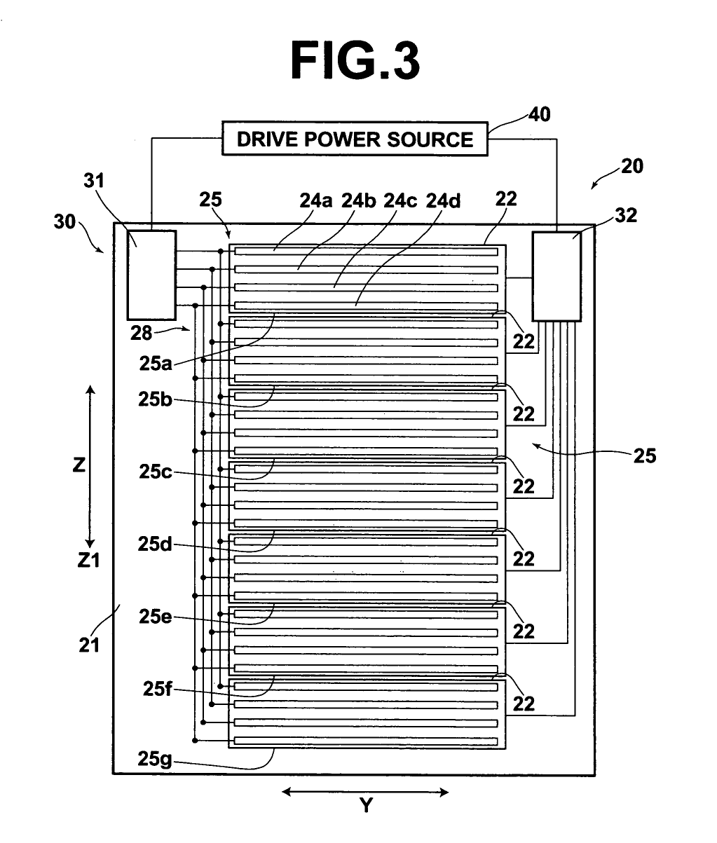

FIG. 3 is a schematic diagram of a preferred embodiment of the panel light source of the present invention, and a panel driver IC will be described hereinafter with reference to FIG. 3. The panel driver IC 30 controls the application of the drive current to the panel light source 20. It includes a cathode driver IC 31 electrically connected to a plurality of line electrodes 24a to 24d, and an anode driver IC 32 electrically connected to a plurality of flat plate electrodes. The cathode driver IC 31 and anode driver IC 32 are electrically connected to a drive power source 40 that outputs the drive current, and supply the drive current to the line electrodes 24a to 24d and flat plate electrodes 22 respectively.

The cathode driver IC 31 may be constituted by a driver IC having current suction type output stages, and the anode driver IC 32 may be constituted by a driver IC having current ejection type output stages.

Each of the corresponding line electrodes 24a to 24d in different EL blocks 25a to 25g is connected in parallel with each other through a wire 28 which is electrically connected to the cathode driver IC 31. More specifically, the number of wires provided is equal to the number of line electrodes 24a to 24d in one EL block 25, and each of the corresponding line electrodes 24a to 24d in EL blocks 25a to 25g is electrically connected with each other through each of the wires 28. The wiring pattern shown in FIG. 3 may be realized by stacking the wires 28 in layers.

In the meantime, the flat plate electrode 22 of each of the EL Blocks 25a to 25g is electrically connected to the anode driver IC 32 which has a function for sequentially switching the flat plate electrode 22 of each of the EL blocks 25a to 25g for applying the drive current. When causing the panel light source 20 to emit the readout light beam, the drive current is applied from the panel driver ICs 31 and 32 to the line electrodes 24a to 24d of a plurality of EL blocks connected with each other through the wires 28, and to the flat plate electrode 22 of the EL block 25 to be caused to emit luminescence respectively.

More specifically, when causing the linear light beam to be scan emitted from the panel light source 20 in the arrow Z1 direction, the drive current is applied to the line electrodes 24a by the cathode driver IC 31. Here, the drive current is applied to the line electrodes 24a of all the EL blocks 25a to 25g. At the same time, the drive current is applied to the flat panel electrode 22 of the EL block 25a by the anode driver IC 32. Then, in the EL block 25a, the linear readout light beam L is emitted from the EL layer 23 sandwiched between the line electrode 24a and flat panel electrode 22 to which the drive current is applied. In the mean time, in the other EL blocks 25b to 25d, no readout light beam L is emitted since the drive current is applied only to the line electrode 24a, but not to the opposing flat panel electrode 22.

Thereafter, the drive current is sequentially applied to the line electrodes 24b, 24c and 24d. Here, the drive current is applied only to the flat panel electrode 22 of the EL block 25a. Consequently, the readout light beam L is scan emitted from the EL layer 23 in the arrow Z1 direction according to the application order of the drive current, in which the drive current is sequentially applied to the line electrodes 24b, 24c and 24d.

Then, the drive current is switched from the flat plate electrode 22 of the EL block 25a to that of the EL block 25b by the anode driver IC 32. In the meantime, the drive current is sequentially applied to the line electrodes 24a, 24b, 24c and 24d by the cathode driver IC 31. Consequently, in the EL block 25b, the linear readout light beam L is scan emitted in the arrow Z1 direction. By causing the EL blocks 25c to 25g to operate in the same manner as described above, the linear readout light beam L is scan irradiated on the image recording medium 10 from the panel light source 20 in the arrow Z1 direction.

Control of the application of the drive current to a plurality of EL blocks 25a to 25g by the cathode driver IC 31 and anode driver 32 in the manner as described above allows emission control of the EL blocks 25a to 25g with a less number of cathode driver ICs 31 and anode driver ICs 32 than the number of blocks. This allows a high yield rate for mounting the driver ICs and enhanced connection reliability thereof with reduced cost. That is, if a panel driver IC is provided for each EL block 25, a number of panel driver ICs corresponding to the number of EL blocks need to be mounted on the panel at a narrow pitch, which causes a problem of decreased yield rate for mounting the IC chips. In contrast, control of all the EL blocks 25a to 25g by the two panel driver ICs 31 and 32 may result in reduced number of panel driver ICs required for drive controlling the panel light source 20.

In addition, the panel driver IC 30 is constructed to control to cause the panel light source 20 to further emit the readout light beams for erasing residual image information remaining in the image recording medium after emitting the readout light beams for reading out the image information from the image recording medium 10. This may prevent image quality degradation due to residual image information when the image recording medium 10 is repeatedly used for recording image information.

Here, a configuration may be adopted in which the drive current is applied to the line electrodes 24a to 24d of all the EL blocks 25a to 25g by the cathode driver IC 31, and sequentially to the flat plate electrode 22 of each of the EL blocks 25a to 25g by the anode driver 32. Then, the readout light beam is irradiated on the image recording medium 10 from the EL blocks 25a to 25g of the panel light source 20 on a block by block basis.

Alternatively, a configuration may be adopted in which the drive current is sequentially applied to each of the line electrodes 24a to 24d of the EL blocks by the cathode driver 31, and simultaneously to the flat plate electrodes 22 of all the EL blocks 25a to 25g by the anode driver 32. In this case, the readout light beam is sequentially scan emitted from the line electrodes 24a, 24b, 24c and 24d in the respective EL blocks 25a to 25g simultaneously. Here, the cathode control driver IC 31 may be constructed to cause the drive current to be applied to the line electrodes 24a to 24d on an electrode by electrode basis, or on the basis of a plurality of electrodes, for example, simultaneous application to the line electrodes 24a and 24b, and to the line electrodes 24c and 24d.

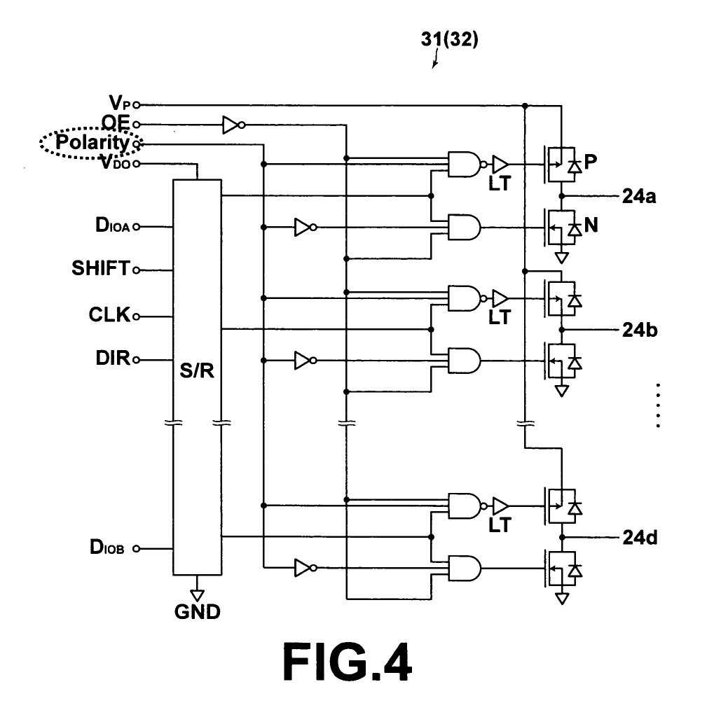

A configuration may be adopted in which a reversely biased current with respect to the drive current is applied to each of the line electrodes 24a to 24d and each of flat plate electrodes 22 of a plurality of EL blocks by the panel driver IC 30 when the readout light beams are further emitted for erasing residual image information remaining in the image recording medium 10. That is, in FIGS. 1 to 3, the readout light beam is emitted with the line electrodes 24a to 24d being set as cathode and the flat plate electrode 22 being set as anode. In the erasing mode, however, a reverse bias current having the same magnitude as that of the drive current may be applied with the line electrodes 24a to 24d being set as anode and the flat plate electrode 22 being set as cathode to emit the readout light beams for erasing residual image information. This may prevent a short or open circuit due to migration within the panel light source 20. Here, in the panel driver IC 31 or 32 shown in FIG. 4, switching between the cathode and anode for each of the line electrodes 24a to 24d may be implemented by switching on/off (high/low) the polarity input.

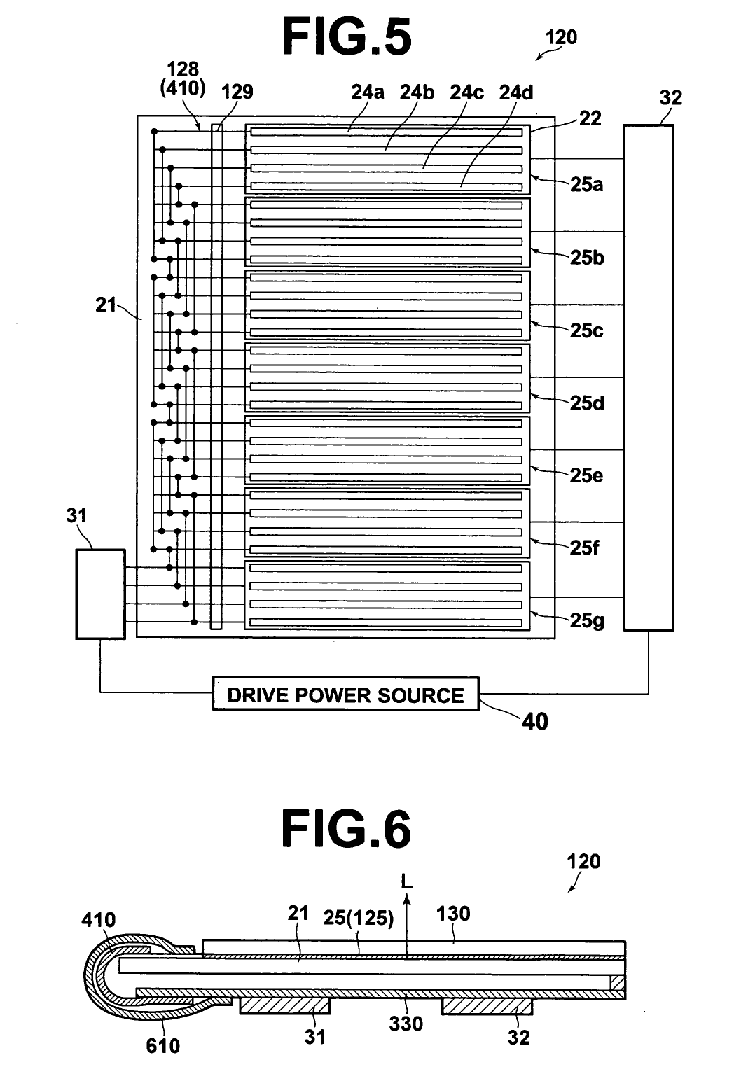

FIGS. 5 to 9 are schematic diagrams illustrating further embodiments of the present invention. Panel light sources 120 to 420 will be described with reference to FIGS. 5 to 9. In the panel light sources 120 to 420 shown in FIGS. 5 to 9, elements having identical structures to those of the panel light source 20 shown in FIG. 3 are given the same reference numerals, and will not be elaborated upon further here.

The panel light source 120 shown in FIGS. 5 and 6 differs from the panel light source 20 shown in FIG. 3 in the implementation method of the wiring pattern and driver IC 30. Each of the line electrodes 24a to 24d and the cathode driver IC 30 are electrically connected with each other by ACF thermocompression bonding at a connecting section 129 that uses flexible printed circuit boards (FPC) 410 and 610. FPC 410 has a wiring pattern of wires 128, and the like formed thereon, and each of the line electrodes 24a to 24d of a plurality of EL blocks 25a to 25g is connected in parallel by the wire 128. In FIG. 6, a protection member 130 made of glass or the like for protecting the plurality of EL blocks 25 is provided thereon.

The use of FPC 410 results in less power consumption due to reduced electrical resistance and less luminance variation compared with the case in which the wires 128 are formed on a substrate 21 as a thin film. That is, the use of ACF thermocompression bonded single-sided FPC 410 allows the connection resistance value between the line electrodes and panel driver IC 30 to be reduced to as low as several ohms. More specifically, if the Cu pattern on the FPC 410 has a thickness of 9 μm, a width of 0.05 mm, and a length of 50 mm with a resistance value of 5 mΩ/square, the resistance value of the connection pattern is 5×10⁻³×50/0.05=5Ω. Assuming that the maximum current flowing each of the EL blocks 25a to 25g is SOMA, the maximum voltage drop developed in the wires 128 is 0.25V, which corresponds to the value that causes a maximum luminance variation of 1% among the linear light beams. This luminance variation causes no image irregularity. Further, considering the voltage drop of 20V developed within the line of an aluminum electrode with a width of 0.05 mm and a length of 430 mm, it is evident that the voltage drop of 0.25V is very small, i.e. as low as approximately 1/100 of that of the aluminum electrode of 20V.

When an identical circuit is formed with a thin film, if aluminum, which is expected to have a low resistance value, is used for connecting each of the corresponding line electrodes 24a to 24d with each other, the sheet resistance value is 0.1Ω/square, which is approximately 20 times as high as that of the FPC. Consequently, the voltage drop arising from the connection of the line electrodes 24a to 24d becomes 5V, causing a maximum luminance variation of 20% among the light beams. This causes a transversal streak to appear on the image, and requires image processing for correction. The use of a thick film allows the sheet resistance value to be reduced to several mΩ/square, but the wiring technology that meets the resolution of 101 p/mm or 201 p/mm of X-ray sensor is still immature.

As described above, the connection of the single-sided FPC using ACF allows the block connection of a micropattern at the lowest cost. An experiment showed that the connection with a pitch of 50 μm corresponding to the resolution value of 201 p/mm may be achieved.

Further, panel driver ICs 31 and 32 are mounted on the surface of the panel light source 120 opposite to the readout light beam emitting surface using a wiring substrate 330. This requires no space on the light emitting surface for mounting the panel driver ICs 31 and 32, which may reduce a gap between a human breast wall and the image recording area of a solid-state detector 10 when taking a mammogram. That is, when obtaining breast image information by bringing the breast into close contact with the image recording medium 10, the readout light beams are not emitted from the regions of the panel light source 20 shown in FIG. 3 where the panel driver ICs 31 and 32 are mounted, so that no image information is read out from the areas of the image recording medium 10 corresponding to the regions. In contrast, the rear mount of the panel driver ICs 31 and 32 as shown in FIG. 6 allows the emission region of the readout light beam L to be extended to the end 120a of the panel light source 120, so that the readout light beams may be irradiated on the end area of the solid-state detector 10 and image information recorded thereon may be read out.

The cathode driver IC 31 shown in FIG. 5 causes the scan driving of the readout light beam L to be performed sequentially in the scanning direction (arrow Z1 direction). The readout light beam L is scanned in the direction of the arrow Z1 in the EL blocks 25a, 25c, 25e, and 25g, and it is scanned in the direction of the arrow Z2 in the EL blocks 25b, 25d, and 25f. Here, the order of the image information obtained from the image recording medium 10 in the areas corresponding to the EL blocks 25a, 25c, 25e and 25g differs from that of the areas corresponding to the EL blocks 25b, 25d, and 25f so that rearrangement of the image information is performed in the signal obtaining unit 50.

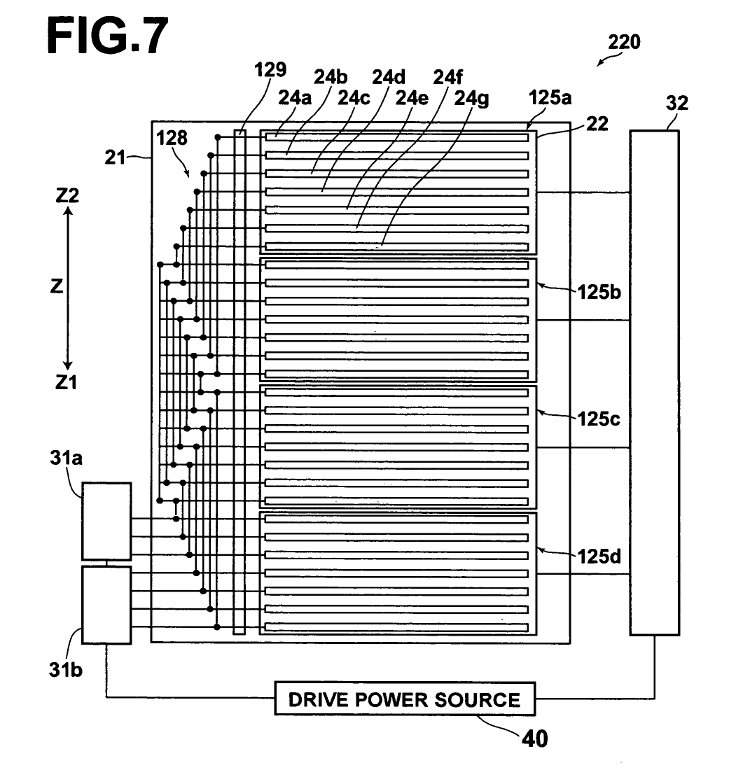

In a panel light source 220 shown in FIG. 7, each of EL blocks 125a to 125d has a greater number of line electrodes 24a to 24g than that of the output stages of the cathode driver IC 31. More specifically, FIG. 7 shows an example case in which each EL block 125 has 7 line electrodes 24a to 24g, whereas a single cathode driver IC 31 has 4 outputs. The panel driver IC 30 includes a plurality of cathode drivers 31a, 31b. The cathode driver ICs 31a, 31b are connected such that their shift registers are connected in series to perform sequential driving in the scanning direction (arrow Z1 direction) of the readout light beam L. The wire connected to the flat plate electrode 22 and the wires 128 connected to the line electrodes 24a to 24g have the same electrode resistance to cancel out the voltage drops.

Then, the readout light beam L is scanned in the direction of the arrow Z1 in the EL blocks 125a, 125c, while it is scanned in the direction of the arrow Z2 in the EL blocks 125b, 125d. Thus, the order of the image information obtained from the image recording medium 10 in the areas corresponding to the EL blocks 125a, 125c differs from that of the areas corresponding to the EL blocks 125b, 125d, so that rearrangement of the image information is performed in the signal obtaining unit 50.

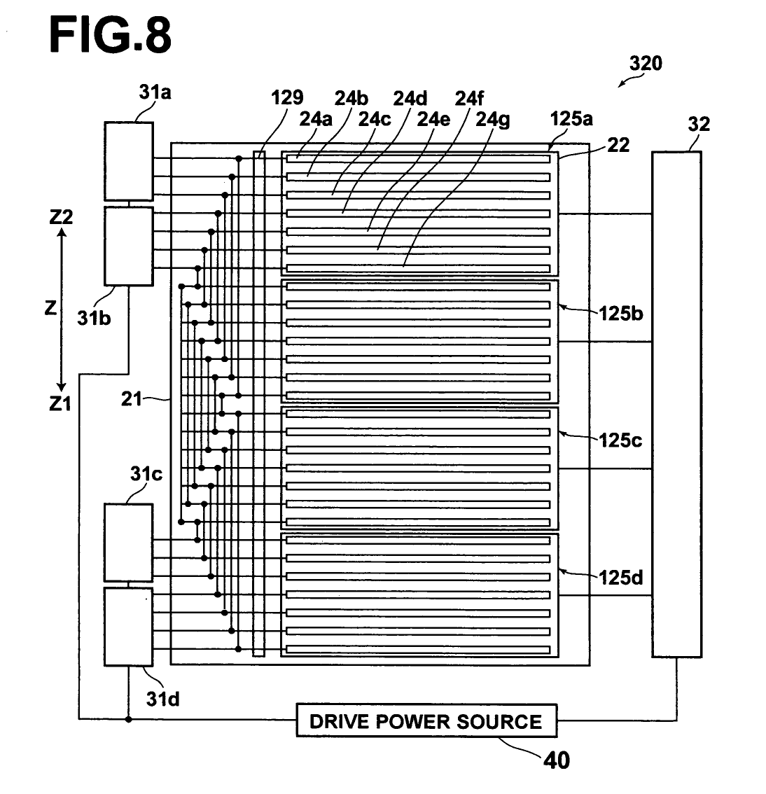

In a panel light source 320 shown in FIG. 8, 7 line electrodes 24a to 24g are drive controlled by 4 cathode driver ICs 31a to 31d. That is, the cathode driver ICs 31a, 31b sequentially drive the line electrodes 24a to 24g in the EL block 25a to scan the readout light beam L in the main scanning direction (arrow Z1 direction). Then, when driving the EL block 25b, the cathode driver ICs 31c, 31d drive the line electrodes 24a to 24g in the EL block 25b to sequentially scan the readout light beam L in the main scanning direction (arrow Z1 direction). Consequently, the readout light beam L is sequentially scanned in the direction of the arrow Z1. Accordingly, no image information rearrangement (FIG. 7) is required in the signal obtaining unit 50.

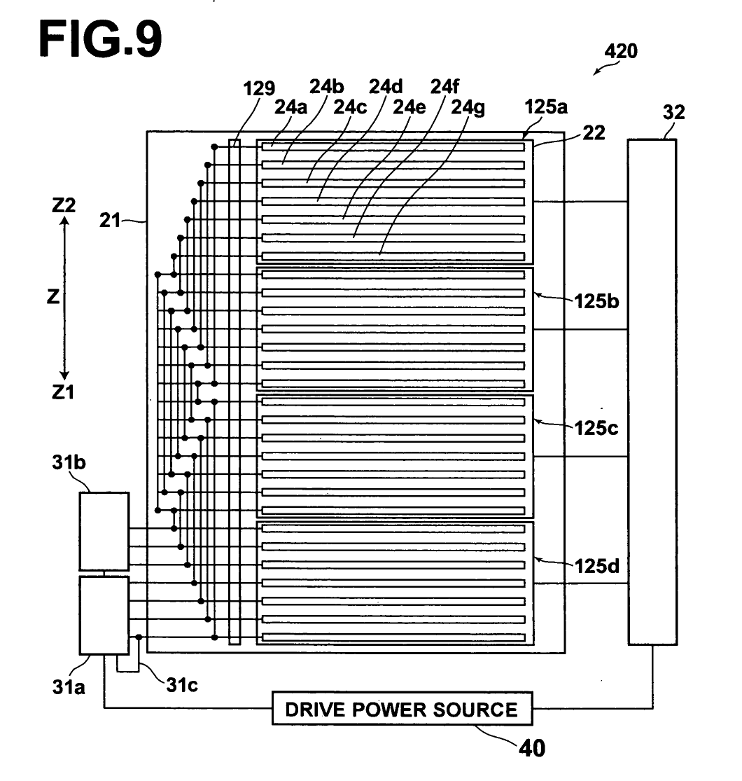

In a panel light source 420 shown in FIG. 9, the panel is drive controlled by two cathode driver ICs 31a, 31b as in the panel light source 220 shown in FIG. 7. But in the present embodiment, a reverse shift input terminal 31c is provided for causing the cathode driver ICs 31a, 31b to perform reverse shifting. In the EL block 125a, the drive current is applied sequentially from the line electrode 24a to 24g (arrow Z1 direction). On the other hand, when driving the EL block 125b, the drive current is applied sequentially from the line electrode 24g to 24a (arrow Z2 direction) by changing the shift direction of the cathode driver ICs 31a, 31b by the input to the reverse shift input terminal, and idly shifting the non-contact outputs of the cathode driver IC 31b.

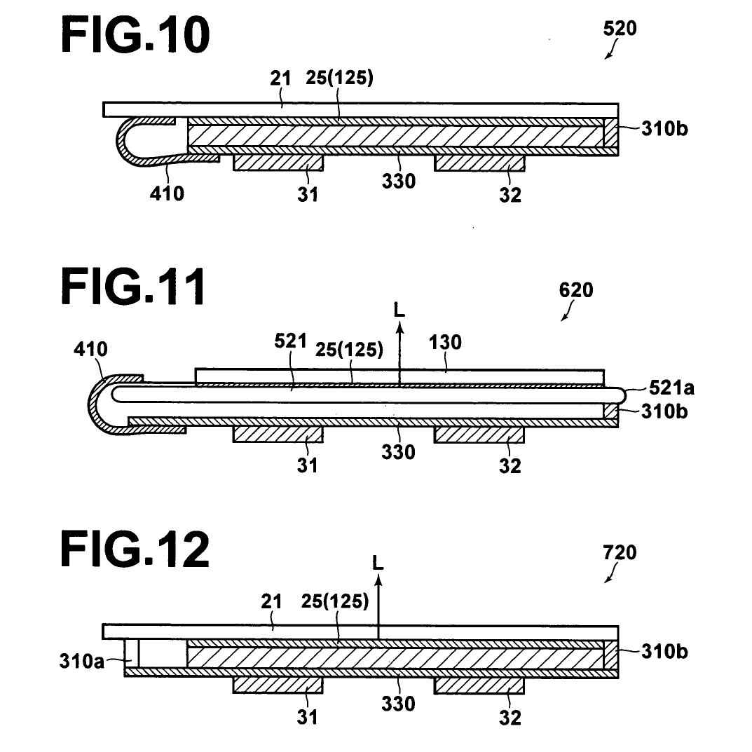

In the mean time, FIG. 6 illustrates an example case in which the panel driver IC 30 is connected to flat plate electrode 22 and line electrodes 24a to 24d by ACF thermocompression bonding using FPC 410, 610. Alternatively, various connection methods including those illustrated in FIGS. 10 to 12 may be used. In FIGS. 10 to 12, elements having identical structures to those shown in FIG. 6 are given the same reference numerals, and will not be elaborated upon further here.

In a panel light source 520 shown in FIG. 10, each flat plate electrode 22 and a wiring substrate 330 are electrically connected with each other using an anisotropically conductive rubber sheet 310b instead of FPC 610. In a panel light source 620 shown in FIG. 11, each of a plurality of flat plate electrodes 22 has a rounded edge 21a at the connection side with the anisotropically conductive rubber sheet 310b. This allows side wiring of up to 61 p/mm. Further, in a panel light source 720 shown in FIG. 12, the wiring substrate 330 is electrically connected to each of the flat plate electrodes 22 and each of the line electrodes 24a to 24d by anisotropically conductive rubber sheets 310a and 310b. The plurality of EL blocks 25 are sealed in a sealing can provided between the substrate 21 and wiring substrate 330.

In the panel light sources 520 to 720 shown in FIGS. 10 to 12, no space is required on the readout light beam emitting surface for mounting the panel driver ICs 31, 32 as in the panel light source 120 shown in FIG. 6. This may reduce a gap between a human breast wall and the image recording area of a solid-state detector 10 when taking a mammogram.

It will be appreciated that embodiments of the present invention are not limited to those described above. For example, in the embodiments described above, an inorganic EL panel using an inorganic EL material is described as the panel light source 20. But the panel light source 20 may be constituted by an organic MPE (multiphoton emission) EL material that uses a high voltage as in the inorganic EL panel described above.

Further, in each of the embodiments, description has been made with reference to an example case in which the cathode driver IC 31 and anode driver IC 32 are employed. But, the panel light source may be drive controlled by a single driver IC. In this case, the drive control by a single driver IC may be achieved, for example, by switching the signal level inputted to the polarity terminal shown in FIG. 4 to H or L to change the setting of the type of the output stages thereof to current suction or current ejection type.

What is claimed is:

1. An image readout apparatus, comprising:
an image recording medium with image information recorded thereon;
a panel light source constituted by electroluminescence elements for emitting linear readout light beams onto the image recording medium; and
a panel driver IC for controlling the application of a drive current to the panel light source such that the readout light beam is scan irradiated on the image recording medium from the panel light source, wherein:
the panel light source is constituted by a plurality of EL blocks arranged side by side, each including a plurality of line electrodes disposed in stripes, and a flat plate electrode disposed opposite to the plurality of line electrodes with an electroluminescence layer interposed therebetween;
each of the corresponding line electrodes in different EL bocks is electrically connected with each other through a wire; and
the panel driver IC applies the drive current to the line electrodes of a plurality of EL blocks connected through the wire, and to the flat plate electrode of the EL block to be caused to emit luminescence when causing the panel light source to emit the readout light beam.

2. The image readout apparatus according to claim 1, wherein each of the corresponding line electrodes in the different EL bocks is connected with each other in parallel.

3. The image readout apparatus according to claim 1, wherein each of the line electrodes is electrically connected to the panel driver IC using a flexible printed circuit board.

4. The image readout apparatus according to claim 1, wherein each of the line electrodes is electrically connected to the panel driver IC using an anisotropically conductive rubber sheet.

5. The image readout apparatus according to claim 1, wherein the panel driver IC is mounted on the surface of the panel light source opposite to the readout light beam emitting surface.

6. The image readout apparatus according to claim 1, wherein the panel driver IC controls to cause the panel light source to further emit the readout light beams for erasing residual image information remaining in the image recording medium after emitting the readout light beams for reading out the image information from the image recording medium.

7. The image readout apparatus according to claim 6, wherein the panel driver IC further includes a function to apply a reversely biased voltage with respect to the drive current to each of the line electrodes and each of the flat plate electrodes of the plurality of EL blocks when causing the readout light beams for erasing residual image information remaining in the image recording medium to be further emitted.
